(19) United States
(12) Patent Application Publication
(10) Pub. No.: US 2019/0026061 A1
(43) Pub. Date: Jan. 24, 2019

(54) Display Device And Display Method Thereof

(71) Applicant: BOE Technology Group Co., Ltd., Beijing (CN)

(72) Inventor: Yongbo Wang, Beijing (CN)

(21) Appl. No.: 15/977,009

(22) Filed: May 11, 2018

(30) Foreign Application Priority Data
Jul. 19, 2017 (CN) 201710590267.4

(51) Int. Cl. G06F 3/14; G09G 5/14; G09G 5/00; G06F 3/147

(52) U.S. Cl. CPC G06F 3/1446; G09G 5/14; G09G 5/006; G09G 2330/12; G09G 2300/026; G09G 2370/042; G06F 3/147

(57) ABSTRACT

A display device and a display method thereof are disclosed. The display device comprises: a spliced screen comprising a plurality of display panels; a plurality of display interfaces electrically connected to the display panels in a one-to-one correspondence; an image processing module configured to respectively output test signals including interface identification information to the plurality of display interfaces, such that each display panel generates a feedback signal including position identification information based on the test signal, the position identification information indicating a position of the display panel in a spliced screen; and a position obtaining module configured to determine a correspondence relationship between each display interface and the position of the display panel to which the display interface is connected according to the interface identification information and the feedback signal. The image processing module is further configured to output a display signal indicating a portion of an image to be displayed to each display interface according to the correspondence relationship, so that the plurality of display panels display the image to be displayed together.

### CROSS-REFERENCE TO RELATED APPLICATION

This application claims the benefit of Chinese Patent Application No. 201710590267.4 filed on Jul. 19, 2017 in the State Intellectual Property Office of China, the whole disclosure of which is incorporated herein by reference.

### BACKGROUND OF THE INVENTION

### Field of the Invention

At least one embodiment of the present disclosure relates to the field of display technology, and in particular, to a display device and display method thereof.

### Description of the Related Art

A spliced screen is an oversized display screen spliced by a plurality of display panels. Each of the plurality of display panels is electrically connected to a display interface in a one-to-one correspondence. When displaying, an image processing module outputs corresponding image information to each display panel via the display interfaces, respectively, so that the images displayed by all the display panels are spliced into an entire image.

At present, during the use of the spliced screen, each display panel is connected to the corresponding display interface by means of manual connection, so that the spliced screen correctly displays the entire image. However, such a method requires a user to remember corresponding relationship of each display panel and its display interface, and to select the correct display interface according to the position of each display panel, which is inconvenient. In particular, with an increase in the number of display panels, the connection operations are more troublesome, and tend to bring forth problems such as splicing errors.

### SUMMARY OF THE INVENTION

At least one embodiment of the present disclosure provides a display device and a display method thereof.

According to the embodiment of the present disclosure, there is provided a display device comprising: a spliced screen including a plurality of display panels; a plurality of display interfaces electrically connected to the display panels in a one-to-one correspondence; an image processing module configured to respectively output test signals including interface identification information to the plurality of display interfaces, so that each display panel generates a feedback signal including position identification information based on the test signal, the position identification information indicating a position of the display panel in the spliced screen; and a position obtaining module configured to determine a correspondence relationship between each display interface and the position of the display panel to which the display interface is connected according to the interface identification information and the feedback signal. The image processing module is further configured to output a display signal indicating a portion of an image to be displayed to each display interface according to the correspondence relationship, so that the plurality of display panels display the image to be displayed together.

According to a display device of an embodiment of the present disclosure, the position obtaining module comprises: a receiving unit configured to receive the feedback signal; and a computing unit configured to match each of the feedback signals with any one of the interface identification information to determine the correspondence relationship between each display interface and the position of the display panel to which the display interface is connected.

According to a display device of an embodiment of the present disclosure, each of the test information is adapted to drive a corresponding display panel to be illuminated to form a screen image on the spliced screen,

the receiving unit includes an image acquisition unit adapted to acquire the screen image as a feedback signal; and

the calculation unit is further configured to identify the screen image and acquire the position identification information indicating the position of each of the lightened display panels in the spliced screen.

According to a display device of an embodiment of the present disclosure, the image processing module is configured to sequentially output test signals, for driving the corresponding display panels to be illuminated, to the plurality of display interfaces, the order of outputting the signals to the plurality of display interface being defined as the interface identification information.

According to a display device of an embodiment of the present disclosure, the computing unit is further configured to sequentially match the position identification information of each display panel with the interface identification information of the corresponding display interface to obtain the correspondence relationship.

According to a display device of an embodiment of the present disclosure, the image processing module is configured to simultaneously output different test signals, for driving the plurality of display panels to emit light, to the plurality of display interfaces, respectively, distinctive feature of each test signal being defined as the interface identification information.

According to a display device of an embodiment of the present disclosure, the computing unit is further configured to match the position identification information of the plurality of display panels and the shape feature of the displayed image with the interface identification information of the plurality of display interfaces to obtain the correspondence relationship.

According to a display device of an embodiment of the present disclosure, the image processing module is further configured to output a display signal corresponding to a portion of a preset verification image to each display interface based on the correspondence relationship. The position obtaining module further includes: a verification unit configured to determine whether the screen image displayed by the spliced screen is the same as the preset verification image, and if they are the same, generate a storage control signal; and a storage unit configured to store the correspondence relationship between the each current display interface and the position of the display panel to which the display interface is connected based on the storage control signal.

According to a display device of an embodiment of the present disclosure, the verification unit comprises: a request subunit configured to issue a verification request to obtaining an operation instruction; a receiving subunit configured to receive the operation instruction; and an analyzing subunit configured to: when the operation instruction received by the receiving subunit is a manual verification instruction, control the request subunit to issue a determination result request, and when the operation instruction received by the receiving subunit is a determination result instruction, determine whether the screen image and the preset verification image are the same according to the determination result; and when the operation instruction received by the receiving subunit is an automatic verification instruction, control the image acquisition unit to acquire the screen image and determine whether the screen image and the preset verification image are the same.

According to a display device of an embodiment of the present disclosure, the position obtaining module further comprises an alert unit configured to issue an alert signal in response to a difference between the screen image and the preset verification image.

According to an embodiment of another aspect of the present disclosure, there is a display method of the display device according to any one of the above mentioned embodiments, comprising the following steps: respectively outputting test signals including interface identification information to the plurality of display interfaces; generating, by each display panel, a feedback signal including position identification information based on the test signal, the position identification information indicating a position of the display panel in the spliced screen; determining, according to the interface identification information and the feedback signal, a correspondence relationship between each display interface and a position of the display panel to which the display interface is connected; and outputting display signal indicating a portion of an image to be displayed to each display interface according to the correspondence relationship, so that the plurality of display panels display the images to be displayed together.

According to a display method of an embodiment of the present disclosure, the step of determining the correspondence relationship between each display interface and the position of the display panel to which the display interface is connected according to the interface identification information and the feedback signal comprises the following steps: receiving the feedback signal; and, matching each of the feedback signals with any one of the interface identification information to determine the correspondence relationship between each display interface and the position of the display panel to which the display interface is connected.

According to a display method of an embodiment of the present disclosure, each test information is adapted to drive a corresponding display panel to be illuminated to form a screen image on the spliced screen. The step of generating, by each display panel, the feedback signal including position identification information based on the test signal includes the following steps: acquiring a screen image as the feedback signal; and identifying the screen image to acquire the position identification information indicating the position of each display panel, which is emitting light, in the spliced screen.

According to a display method of an embodiment of the present disclosure, the step of determining the correspondence relationship between each display interface and the position of the display panel to which the display interface is connected according to the interface identification information and the feedback signal comprises: sequentially outputting the test signals, for driving the respective display panels to emit light, to the plurality of display interfaces, the order of outputting the test signals to the plurality of display interfaces being defined as the interface identification information.

According to a display method of an embodiment of the present disclosure, the position identification information of each display panel is sequentially matched with the interface identification information of the corresponding display interface to obtain the correspondence relationship.

According to a display method of an embodiment of the present disclosure, different test signals, for driving the plurality of display panels to emit light, are simultaneously outputted to the plurality of display interfaces, respectively, and distinctive feature of each test signal being defined as the interface identification information.

According to a display method of an embodiment of the present disclosure, the step of determining the correspondence relationship between each display interface and the position of the display panel to which the display interface is connected according to the interface identification information and the feedback signal comprises: matching the position identification information of the screen images of the plurality of display panels and the shape features of the displayed images with the interface identification information of the plurality of display interfaces to obtain the correspondence relationship.

According to a display method of an embodiment of the present disclosure, before performing the step of outputting the display signal indicating the portion of the image to be displayed to each display panel according to the correspondence relationship, the display method further comprises the following steps: outputting display signal corresponding to a portion of the preset verification image to each display interface according to the correspondence relationship; and determining whether the screen image displayed by the spliced screen and the preset verification image are the same, and if they are the same, storing the correspondence relationship between each current display interface and the position of the display panel to which the display interface is connected.

According to a display method of an embodiment of the present disclosure, the step of determining whether the screen image displayed by the spliced screen and the preset verification image are the same includes the following steps: issuing a verification request for obtaining an operation instruction; receiving the operation instruction, and when the received operation instruction is a manual verification instruction, issuing a determination result obtaining request, and when the received operation instruction is a determination result instruction, determining whether the screen image and the preset verification image are the same according to the determination result instruction; and when the received operation instruction is an automatic verification instruction, acquiring the screen image, and determining whether the screen image and the preset verification image are the same.

According to a display method of an embodiment of the present disclosure, if it is determined that the screen image is different from the preset verification image, then an alert signal is issued.

### BRIEF DESCRIPTION OF THE DRAWINGS

The accompanying drawings are provided for better understanding of the present disclosure, and constitute a portion of the present disclosure. Further, the accompanying drawings, in conjunction with following embodiments, are intended to explain the present disclosure, but are not to limit the present disclosure, wherein:

FIG. 1 is a block diagram of a display device according to an exemplary embodiment of the present disclosure;

FIG. 2 is a schematic block diagram of a position obtaining module shown in FIG. 1;

FIG. 3 is a block diagram of an exemplary embodiment of the position obtaining module shown in FIG. 2;

FIG. 4a is a schematic diagram showing a display effect of the spliced screen when a display interface H1 outputs a test signal;

FIG. 4b is a schematic diagram showing a display effect of the spliced screen when a display interface H2 outputs a test signal;

FIG. 4c is a schematic diagram showing a display effect of the spliced screen when a display interface H3 outputs a test signal;

FIG. 4d is a schematic diagram showing a display effect of the spliced screen when a display interface H4 outputs s test signal;

FIG. 5 is a schematic diagram showing a display effect of the spliced screen when all display interfaces output a test signal indicating a preset verification image;

FIG. 6 is an overall flow chart of a display method of a display device according to an exemplary embodiment of the present disclosure;

FIG. 7 is a flowchart of an exemplary embodiment for performing a step S1 in the display method shown in FIG. 6; and

FIG. 8 is a flowchart of an exemplary embodiment for performing a step S4 in the display method shown in FIG. 6.

### DETAILED DESCRIPTION OF PREFERRED EMBODIMENTS OF THE INVENTION

Embodiments of the present disclosure will be described in further detail below with reference to the accompanying drawings. It should be appreciated that the embodiments described herein are merely for the purpose of describing and explaining the present disclosure, but are not intended to limit the present disclosure.

Terms ‘first’ and ‘second’ are merely for the purpose of description, and should not be construed as indicating or implying relative importance or implicitly indicating the number of technical features referred to. Thus, features defined with ‘first’, ‘second’ may explicitly or implicitly include one or more of the features. In the description of the embodiments of the present disclosure, the meaning of ‘plurality’ is two or more, unless otherwise specified.

In the description of the embodiments of the present disclosure, it should be noted that terms ‘mount’, ‘connect’, and ‘connection’ should be interpreted broadly, unless specifically defined or limited otherwise. For example, it may be a mechanical connection, such as a fixed connection, or a detachable connection, or an integral connection, and it may also be an electrical connection, such as a direct electrical connection, or an indirect electrical connection, or a wireless electrical connection. An ordinary person skilled in the art can understand the specific meaning of the aforementioned terms in the context of the embodiments of the present disclosure.

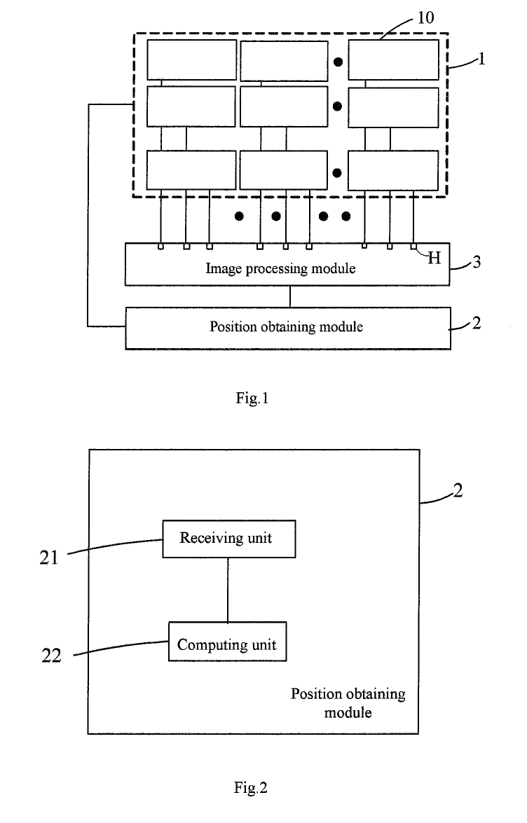

According to an aspect of the present disclosure, there is provided a display device, as shown in FIG. 1, including a spliced screen 1, a position obtaining module 2, a plurality of display interfaces H, and an image processing module 3. The spliced screen 1 includes a plurality of display panels 10, for example, arranged in an array structure, the display panels 10 being electrically connected to the display interfaces H in one-to-one correspondence. The image processing module 3 is configured to output test signals, including interface identification information for indicating a specific display interface which outputs the test signal, to the plurality of display interfaces H at a position obtaining stage, respectively, so that each display panel 10 generates a feedback signal, including position identification information that indicates the position of the display panel in the splicing screen. The position obtaining module 2 is configured to determine a correspondence relationship between each display interface H and the position of the display panel 10, which is connected to the display interface H, according to the interface identification information and the feedback signal when each display interface H outputs the test signal. The image processing module 3 is further configured to output a display signal indicating a portion of the image to be displayed to each display interface H according to the correspondence relationship between each display interface H and the position of the display panel 10, which is connected to the display interface H, at a display stage, so that the plurality of display panels 10 display the image to be displayed together.

In an embodiment, as shown in FIGS. 1 and 2, the position obtaining module 2 includes a receiving unit 21 configured to receive the feedback signal, and a computing unit 22 configured to match each feedback signal with any one of the interface identification information to determine the correspondence relationship between each display interface H and the position of the display panel 10 which is connected to the display interface H.

In an embodiment, each test information output from the display interface H is adapted to drive the corresponding display panel 10 to be illuminated so as to form a screen image on the spliced screen. As shown in FIGS. 1-3, the receiving unit 21 includes an image acquisition unit 211 adapted to acquire the screen image as a feedback signal and send the screen image to the computing unit 22. The computing unit 22 is further configured to identify the screen image and acquire the position identification information indicating the position of each display panel, which is emitting light, in the spliced screen. In this way, each feedback signal may be further matched with any one of the interface identification information to determine the correspondence relationship between each display interface and the position of the display panel which is connected to the display interface H.

In the embodiment of the present disclosure, the display interface H is arranged as a set of signal output terminals related to the display panels that may output a set of display data at the display stage in order to drive the display panels to display the image to be displayed on the spliced screen. In the present disclosure, the display interface comprises a High-Definition Multimedia Interface (HDMI) interface.

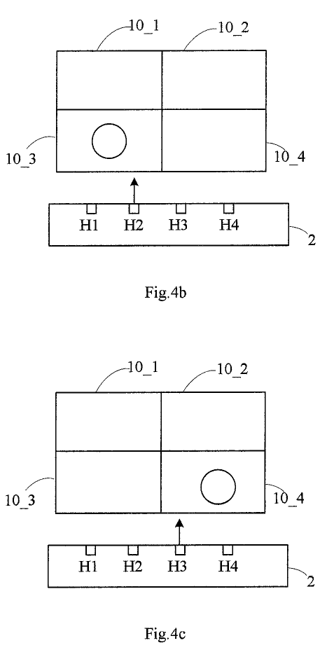

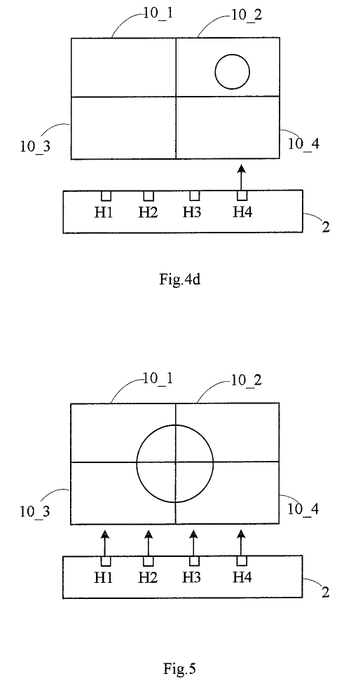

For example, as shown in FIGS. 4a-4d, the spliced screen 1 includes four display panels 10_1, 10_2, 10_3, and 10_4 arranged in two rows and two columns, and four display interfaces H1 to H4 are provided. At the position obtaining stage before the display stage, the image processing module 3 sequentially outputs to the display interfaces H1˜H4 the test signals for driving the display panels 10_1, 10_2, 10_3, and 10_4 to display, and the sequence of outputting the test signals to the display interfaces is defined as the interface identification information. In this case, the interface identification information is defined to represent one specific display interface. In FIGS. 4a-4d, the output of the test signal is indicated by an arrow, and the display panel being illuminated is indicated by the display panel displaying a circular image. The image acquisition unit 211 of the position obtaining module 2 detects that the illuminating sequence of the display panels is 10_1, 10_3, 10_4, 10_2 and the position of the illuminated display panel to obtain a feedback signal, and transmits the detected feedback signal in sequence to the computing unit, and thus the obtained correspondence relationship between the display interface and the position of the display panel is: the display panel 10_1 connected to the display interface H1 is located in the first row and first column of the spliced screen 1, and the display panel 10_3 connected to the display interface H2 is located in the second row and first column of the spliced screen, the display panel 10_4 connected to the display interface H3 is located in the second row and the second column of the spliced screen 1, and the display panel 10_2 connected to the display interface H4 is located in the first row and the second column of the spliced screen 1. Then, when the image is displayed at the display stage, the image to be displayed is stretched to conform to the size of the spliced screen 1, and image data corresponding to the upper left portion of the image to be displayed is output to the display interface H1, image data corresponding to the lower left portion of the image to be displayed is output to the display interface H2, image data corresponding to the lower right portion of the image to be displayed is output to the display interface H3, and image data corresponding to the upper right portion of the image to be displayed is output to the display interface H4, so that the four display panels 10_1˜10_4 display the entire image to be displayed together.

It should be appreciated that in the case of sequentially outputting the test signals, the order of outputting the test signals to a plurality of display interfaces is defined as the interface identification information, wherein all of the test signals may be identical to one another (for example, the display panels all display a circular image), or may be different from one another (for example, the display panels display geometric images having different shapes), as long as the image displayed on the spliced screen 1 may be acquired by the image acquisition unit. Further, under the driving of the test signal, each display panel 10 may display an image, or it may only emit white light. The computing unit 22 identifies the position of each image (for example, a circle image) of an identification picture acquired by the image acquisition unit 211, so that the position identification information of each display panel is obtained. Then, the computing unit 22 sequentially matches the position identification information of each display panel with the interface identification information of the corresponding display interface, that is, the order of the output test signals of the corresponding display interface, which is the lighting sequence of the display panels, to determine the correspondence between each display interface and the position of the display panel to which the display interface is connected.

In an alternative embodiment, the image processing module 3 is configured to simultaneously output different test signals, for driving the plurality of display panels 10 to emit light, to the plurality of display interfaces H, respectively, and the distinguishing feature of each test signal is defined as the interface identification information. In this way, the images displayed on the plurality of display panels H are different from one another. The image acquisition unit acquires the images displayed on the entire spliced screen to obtain the identification picture. In one embodiment, different animal images are displayed on the display panels 10 respectively. For example, in the case that the display panels are arranged as a 3*4 array, the 12 display panels 10 display images of Chinese zodiac respectively. In this way, the feedback information includes the position and shape, i.e., the position identification information and shape features, of each image (animal) of the recognition picture acquired by the image acquisition unit. Then, the computing unit 22 determines the correspondence relationship between each display interface and the position of the display panel which is connected to the display interface by matching the distinguishing feature (interface identification information) of the test signal output by each display interface with the obtained shape feature and position identifying information.

According to the display device of the embodiment of the present disclosure, since the position obtaining module may obtain the correspondence relationship between each display interface H and the position of the display panel 10 to which the display interface H is connected, even if the display panel 10 and the display interface H are randomly connected, the position obtaining module 2 may obtain the position of the display panel 10, to which each display interface H is actually connected, in the spliced screen 1. In this way, display data is distributed to the display panel 10 according to the specific position of each display panel 10 so that the spliced screen including the plurality of display panels may display an entire image. When using the display device of the embodiment of the present disclosure, a user is not required to specifically memorize the correspondence relationship between each display panel 10 and the display interface H, thereby avoiding the occurrence of a splicing error.

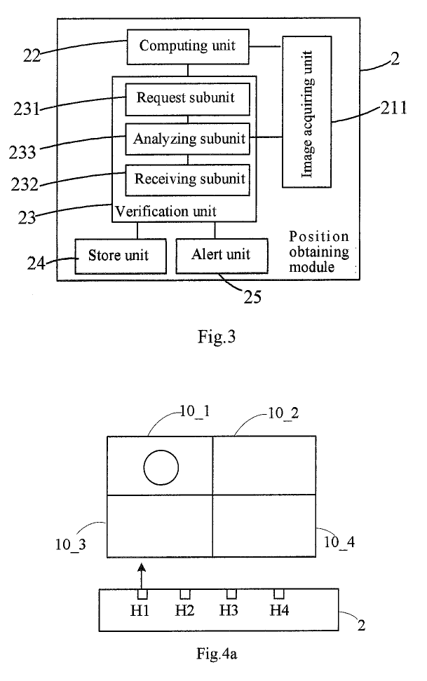

In the above embodiment of the present disclosure, the position obtaining module 2 obtains the position of the illuminated display panel 10 in the spliced screen 1 by means of image acquisition. As shown in FIG. 3, the image acquisition unit 211 is used to acquire the screen image of the spliced screen 1, and particularly may include a camera, such as a digital camera. The computing unit 22 is configured to obtain the position of the illuminated display panel 10 in the spliced screen 1 according to the screen image of the spliced screen 1. Of course, the position obtaining module 2 may also be other structure that may determine the position of the illuminated display panel 10 in the spliced screen 1.

Further, as shown in FIG. 3, the position obtaining module 2 may further include a verification unit 23, a storage unit 24, and an alert unit 25. The image processing module is further configured to, after the position obtaining stage and before the display stage, output a display signal corresponding to a part of a preset verification image to each display interface H according to the correspondence relationship between each display interface H and the position of the display panel 10 to which the display interface H is connected, in order to enable each display interface H to output the part of the preset verification image. The verification unit 23 is configured to determine whether the screen image displayed by the spliced screen 1 is the same as the preset verification image. If they are the same, a storage control signal is generated. The storage unit 24 is configured to store the correspondence relationship between each current display interface H and the position of the display panel 10 to which the current display interface H is connected based on the storage control signal. If they are different, the alert unit 25 issues an alert signal.

Similarly, taken the spliced screens in FIGS. 4a-4d as an example, after obtaining the correspondence relationship between each display interface H and the position of the display panel 10 to which the display interface H is connected, before outputting the display data of the images to be displayed to the corresponding display interfaces H, the display data of the preset verification image is outputted to each display interface H, that is, the image data corresponding to the upper left part of the preset verification image is outputted to the display interface H1, and the image data corresponding to the lower left part of the preset verification image is outputted to the display interface H2, the image data corresponding to the lower right part of the preset verification image is outputted to the display interface H3, and the image data corresponding to the upper right part of the preset verification image is outputted to the display interface H4, so that each display panel displays a portion of the preset verification image. FIG. 5 is a schematic diagram showing a display effect of the spliced screen when all display interfaces output test signals indicating the preset verification image. After finishing the display, as shown in FIG. 5, if the image (for example, a circular image) displayed by the spliced screen 1 is the same as the preset verification image, it indicates that the correspondence relationship obtained by the position obtaining module 2 is correct, and then the correspondence relationship is stored; if they are different, it indicates that the correspondence relationship obtained by the position obtaining module 2 is incorrect, and an alert signal is generated to remind the user to perform exception handling.

As shown in FIG. 3, the verification unit 23 may specifically include a request subunit 231, a receiving subunit 232, and an analyzing subunit 233. The request subunit 231 is configured to issue a verification request to request for obtaining an operation instruction, which includes a manual verification instruction and an automatic verification instruction. The receiving subunit 232 is configured to receive the operation instruction, and may specifically include an infrared receiving end. The analyzing subunit 233 is configured to control the request subunit 231 to issue a determination result request when the operation instruction received by the receiving subunit 232 is a manual verification instruction, and to determine whether the screen image displayed by the spliced screen 1 is the same as the preset verification image when the operation instruction received by the receiving subunit 232 is a determination result instruction instruct according to the determination result instruction. On the other hand, the analyzing subunit 233 is further configured to control the image acquiring unit 211 to acquire the screen image on the spliced screen 1 when the operation instruction received by the receiving subunit 232 is an automatic verification instruction, and to determine, according to the image information of the screen image and the image information of the preset verification image, whether the image displayed by the spliced screen 1 is the same as the preset verification image.

In the above embodiment, the image processing module 3 may output the display data (test signal) to one of the display panels 10 or the entire spliced screen 1 according to the verification request so as to display requesting the user to input operation instructions. The operation instruction and the determination result instruction may be input by a user using an input device (e.g., a remote control) to the receiving subunit 232. Specifically, after the image processing module 3 outputs the display data of the preset verification image to each display interface H, the user may perform subjective judgment and input a manual verification instruction. When the receiving subunit 232 receives the manual verification instruction, the analyzing subunit 233 controls the request subunit 231 to issue an instruction obtaining request for obtaining a determination result instruction. If the user determines that the image displayed by the spliced screen 1 is the same as the verification image, the determination result instruction that they are the same is inputted to the receiving subunit 232 by the input device, so that the analyzing subunit 233 determines that the image displayed by the spliced screen 1 is the same as the preset verification image according to the determination result instruction. Alternatively, after the image processing module 3 inputs the display data of the preset verification image to each display interface H, the user inputs an automatic verification instruction by the input device; after the receiving subunit 232 receives the automatic verification instruction, the analyzing subunit 233 controls the image acquisition unit 211 to acquire the screen image of the spliced screen 1. When the image information of the screen image and the image information of the preset verification image are the same, the analyzing subunit 233 determines that the image displayed by the spliced screen 1 is the same as the preset verification image; otherwise, the analyzing subunit 233 determines that the image displayed by the spliced screen 1 is different from the preset verification image.

In the embodiment of the present disclosure, when the image processing module 3 outputs test signals to the plurality of display interfaces H at the position obtaining stage, the test signal may only illuminated the display panel, or may also cause the display panel 10 to display the image having the specific content. For example, each display panel 10 displays a preset verification image, such as an image of an animal.

The embodiments of the present disclosure have been described above taken an example of using the image acquisition unit to determine the position of the display panel at the position obtaining stage, but the embodiments of the present disclosure are not limited thereto. In an alternative embodiment, as shown in FIG. 2, the receiving unit 21 includes a plurality of positioning devices, such as GPS (Global Positioning System) positioning device or Beidou positioning device. The positioning devices may be respectively installed at the positions for mounting the display panel 10, or may be respectively mounted on the display panel 10 or built in the display panel. The image processing module sequentially outputs test signals to the display interface H, and the sequence of outputting the test signals to the plurality of display interfaces is defined as the interface identification information. At the time of the test signal being sequentially input to the corresponding display panel, the positioning device is triggered to generate the position identification information indicating the position of the display panel, and the position identification information may be transmitted to the computing unit 22 of the position obtaining module 2 via wire or wireless transmission. The computing unit 22 matches the order of the output test signals of each display interface with the order of the currently obtained position identification information and the positioning identification information output by the positioning device, in order to determine the correspondence relationship between each display interface and the position of the display panel to which the display interface is connected.

The embodiments of the present disclosure have been described above taken the test signal driving the light emission of the display panel as an example, but the embodiments of the present disclosure are not limited thereto. For example, in the case where the position of the display panel is determined using a GPS positioning device, the test signal may include a pulse signal. The pulse signal from the display interface H may not drive the display panel to emit light, but may be sufficient to trigger the positioning device to generate the position identification information indicating the position of the display panel.

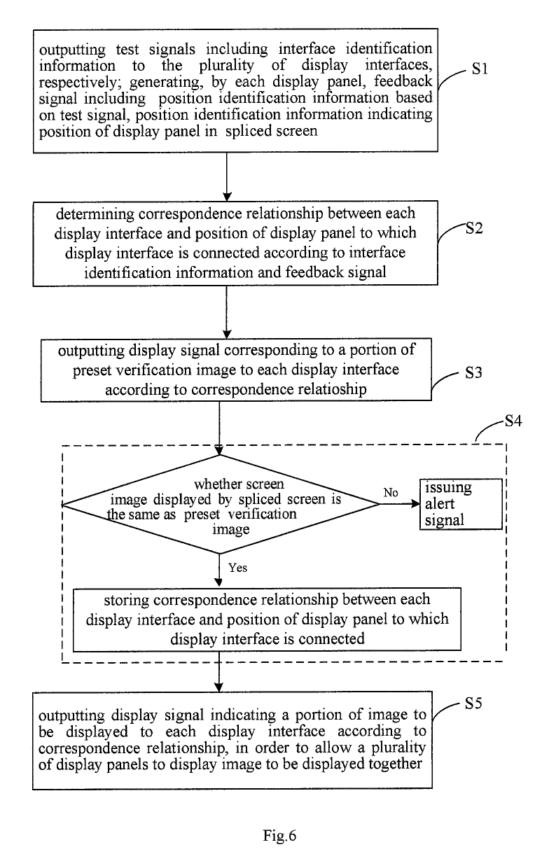

With reference to FIGS. 1 and 4-6, according to an embodiment of another aspect of the present disclosure, there is provided a display method for the display device according to any one of the above embodiments, comprising the following steps:

S1. at the position obtaining stage, respectively outputting, by the plurality of display interfaces H of the image processing module 3, test signals including interface identification information; generating, by each display panel, a feedback signal including the position identification information based on the test signal, the position identification information indicating the position of the display panel H in the spliced screen 1;

S2. determining a correspondence relationship between each display interface H and the position of the display panel 10 to which the display interface H is connected, according to the interface identification information and the feedback signal; and

S5. at the display stage outputting, by the image processing module 3, display signals indicating a portion of the image to be displayed to each display interface H, according to the correspondence relationship between each display interface H and the position of the display panel 10 to which the display interface H is connected, in order to allow the plurality of display panels 10 to display the images to be displayed together.

The position obtaining stage may be regarded as such a period that: during the user uses the display device, after the display panel 10 of the spliced screen 1 is connected to the display interface H of the image processing module 3 in a one-to-one correspondence, and before the display device displays the image according to the input by the signal source.

In an embodiment, the step of determining the correspondence relationship between each display interface H and the position of the display panel 10 to which the display interface H is connected according to the interface identification information and the feedback signal includes the steps of: receiving the feedback signal; and, comparing each feedback signals with any one of the interface identification information to determine the correspondence relationship between each display interface H and the position of the display panel 10 to which the display interface H is connected.

In one embodiment, each of the test information is adapted to drive a corresponding display panel H to be illuminated to form a screen image on the spliced screen 1, and the step of generating by each display panel H feedback signals including the position identification information based on the test signal includes the steps of: acquiring the screen image as a feedback signal; and identifying the screen image to obtain the position identification information indicating the position of each light-emitting display panel H in the spliced screen 1. In this way, each of the feedback signals may be further matched with any one of the interface identification information to determine the correspondence relationship between each display interface and the position of the display panel to which the display interface is connected.

In one embodiment, a test signal for driving a corresponding display panel to be illuminated is sequentially output to the plurality of display interfaces, and the order of outputting test signals to a plurality of display interfaces is defined as the interface identification information. In this case, the interface identification information represents a specific display interface.

It should be appreciated that in the case of sequentially outputting test signals, all the test signals may be the same as one another (for example, the display panels all display a circular image), or may be different from one another (for example, the display panels display geometric images with different shapes), as long as the image displayed on the spliced screen 1 may be acquired by the image acquisition unit. The position of each image (for example, a circular image) on the recognition picture acquired by the image acquisition unit 211 is recognized by the computing unit 22, in order to obtain position identification information of each display panel. After that, by sequentially matching the position identification information of each display panel with the interface identification information output by the corresponding display interface, that is, the order of the test signals of the corresponding display interface, which is the lightening sequence of the display panel, to determine the correspondence relationship between each display interface and the positions of the display panel to which the display interface is connected.

In an alternative embodiment, the image processing module 3 simultaneously outputs different test signals, for driving the plurality of display panels 10 to emit light, to the plurality of display interfaces H, respectively. The distinguishing feature of each test signal is defined as the interface identification information. In this way, the images displayed on the plurality of display panels H are different from one another. The image on the entire spliced screen is acquired by the image acquisition unit to obtain the identification picture. In one embodiment, different animal images are displayed on the display panels 10 respectively. For example, in the case that the display panels are arranged as a 3*4 array, the 12 display panels 10 display images of animals of the Chinese zodiac respectively. In this way, the feedback information includes the position and shape, i.e., the position identification information and shape features, of each image (animal) on the identification picture acquired by the image acquisition unit. Then, the computing unit 22 determines the correspondence relationship between each display interface and the positions of the display panels to which the display interface is connected by matching the distinguishing feature (interface identification information) of the test signal output by each display interface with the obtained position identification information and the shape features of the displayed image.

In the above embodiment, the step of obtaining the position of the illuminated display panel 10 in the spliced screen 1 by the position obtaining module 2 includes a step of: acquiring the screen image of the spliced screen 1 by the position obtaining module 2, and obtaining the position of the lit display panel 10 in the spliced screen 1 according to the screen image.

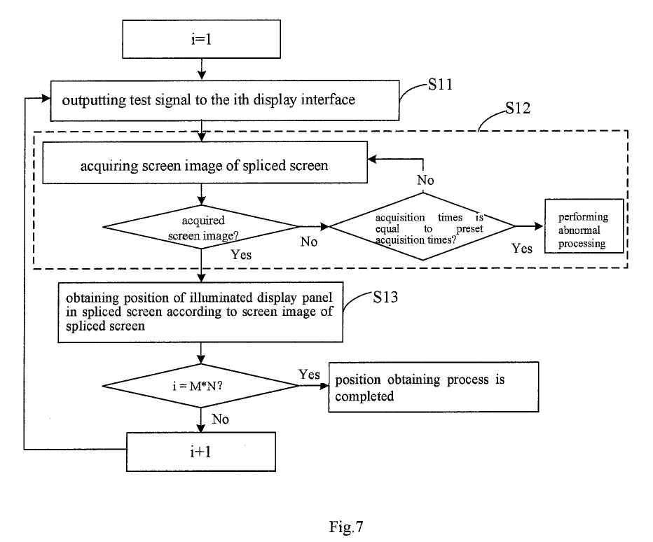

Assumed that the spliced screen 1 includes M rows and N columns of display panels, in an embodiment, as shown in FIG. 7, the step S1 includes the following steps:

S11: outputting a test signal to the ith display interface;

S12. acquiring the screen image of the spliced screen 1, wherein the screen image of the spliced screen 1 may be acquired by the above-mentioned image acquisition unit 211; the acquisition times may be preset (for example, 5 times); if the screen image is not acquired when the acquisition times performed by the image acquisition unit 211 has reached the preset acquisition times, then prompt the user to perform abnormal processing.

S13: obtaining a position of the illuminated display panel 10 in the spliced screen 1 according to the screen image of the spliced screen 1 so as to obtain the position identification information of the illuminated display panel.

S14: determining whether i is equal to M*N, and if yes, the position obtaining process is completed; and if not, outputting a test signal to the next display interface H.

According to an embodiment of the present disclosure, before performing the step of outputting display signal indicating a portion of the image to be displayed to each display panel according to the correspondence relationship, the display method further includes the following steps:

S3, controlling the image processing module 3 to output a display signal corresponding to a portion of the preset verification image to each display interface H according to the correspondence relationship between each display interface H and the position of the display panel 10 to which the display interface H is connected; and

S4. determining whether the screen image displayed by the spliced screen 1 is the same as the preset verification image, wherein if they are the same, then storing the correspondence relationship between the current each display interface H and the position of the display panel 10 to which the display interface is connected; and if not, issuing an alert signal.

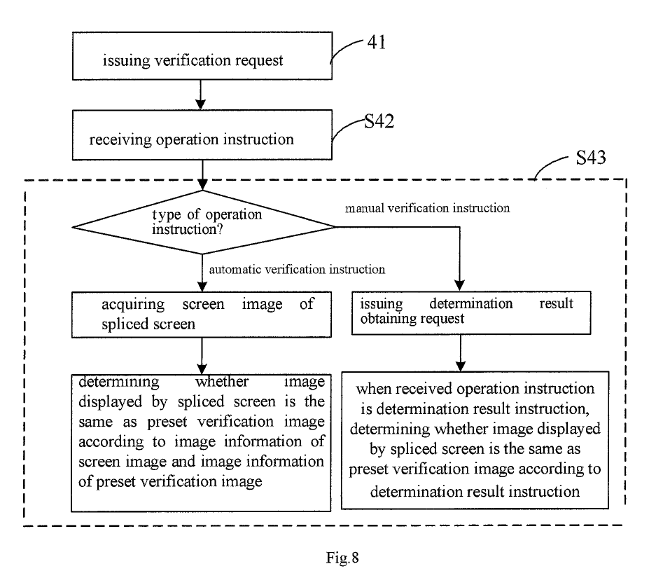

In an embodiment, as shown in FIG. 8, the step of determining whether the image displayed by the spliced screen 1 is the same as the preset verification image includes the following steps:

S41. issuing a verification request to request for obtaining an operation instruction, the verification instruction including a manual verification instruction and an automatic verification instruction, and the operation instruction being sent by the above-mentioned request subunit 231.

S42. receiving the verification instruction, particularly by the above-mentioned receiving subunit 232.

S43: when the received operation instruction is a manual verification instruction, issuing a determination result obtaining request, and when the received operation instruction is a determination result instruction, determining whether the screen image displayed by the spliced screen 1 is the same as the preset verification image according to the determination result instruction; when the received operation instruction is an automatic verification instruction, acquiring the screen image of the spliced screen 1, and determine whether the screen image displayed by the spliced screen 1 is the same as the preset verification image according to the image information of the screen image and the image information of the preset verification image. These steps may be performed by the above-mentioned analyzing subunit 233 and are not described here.

The display method further includes a step S5, at the display stage, according to the correspondence relationship between each display interface H and the position of the display panel 10 to which the display interface is connected, outputting, by the image processing module 3, a display signal indicating a portion of the image to be displayed to each display interface H, so as to allow the plurality of display panels 10 to display the images to be displayed together.

According to the display method of the embodiment of the present disclosure, since the position obtaining module may obtain the correspondence relationship between each display interface H and the position of the display panel 10 to which the display interface is connected, even if the display panel 10 and the display interface H are randomly connected, the position obtaining module 2 may also obtain the actual position of the display panel 10 which is connected to each display interface H in the spliced screen 1. In this way, according to the specific position of each display panel 10, display data is distributed to the display panel 10 so that a spliced screen including a plurality of display panels displays an entire picture. When using the display device of the embodiment of the present disclosure, it is not necessary for the user to specifically memorize the correspondence relationship between each display panel 10 and the display interface H, thereby avoiding the occurrence of a splicing error.

It should be understood that the above embodiments are merely exemplary embodiments employed to illustrate the principle of the present disclosure, but the present disclosure is not limited thereto. Various changes and modifications may be made by a person of ordinary skill in the art without departing from the spirit and essence of the present disclosure, and these changes and modifications are also considered to be within the protection scope of the present disclosure.

What is claimed is:

1. A display device comprising:
a spliced screen including a plurality of display panels;
a plurality of display interfaces electrically connected to the display panels in a one-to-one correspondence;
an image processing module configured to output test signals including interface identification information to the plurality of display interfaces, respectively, so that each display panel generates a feedback signal including position identification information based on the test signal, the position identification information indicating a position of the display panel in the spliced screen; and
a position obtaining module configured to determine a correspondence relationship between each display interface and the position of the display panel to which the display interface is connected according to the interface identification information and the feedback signal,
wherein the image processing module is further configured to output a display signal indicating a portion of an image to be displayed to each display interface according to the correspondence relationship, so that the plurality of display panels display the image to be displayed together.

2. The display device of claim 1, wherein the position obtaining module comprises:
a receiving unit configured to receive the feedback signal; and
a computing unit configured to match each feedback signal with any one of the interface identification information to determine the correspondence relationship between each display interface and the position of the display panel to which the display interface is connected.

3. The display device according to claim 2, wherein each test information is adapted to drive a corresponding display panel to be illuminated to form a screen image on the spliced screen,
wherein the receiving unit includes an image acquisition unit adapted to acquire the screen image as a feedback signal; and
wherein the calculation unit is further configured to identify the screen image and acquire the position identification information indicating the position of each of the illuminated display panels in the spliced screen.

4. The display device according to claim 3, wherein the image processing module is configured to sequentially output test signals, for driving the corresponding display panels to be illuminated, to the plurality of display interfaces, the order of outputting the signals to the plurality of display interfaces being defined as the interface identification information.

5. The display device according to claim 4, wherein the computing unit is further configured to sequentially match the position identification information of each display panel with the interface identification information of the corresponding display interface to obtain the correspondence relationship.

6. The display device according to claim 3, wherein the image processing module is configured to simultaneously output different test signals, for driving the plurality of display panels to emit light, to the plurality of display interfaces, respectively, distinguishing feature of each test signal being defined as the interface identification information.

7. The display device according to claim 6, wherein the computing unit is further configured to match the position identification information of the plurality of display panels and the shape feature of the displayed image with the interface identification information of the plurality of display interfaces to obtain the correspondence relationship.

8. The display device according to claim 3, wherein the image processing module is further configured to output a display signal corresponding to a portion of a preset verification image to each display interface based on the correspondence relationship; and
wherein the position obtaining module further includes:
a verification unit configured to determine whether the screen image displayed by the spliced screen is the same as the preset verification image, and if they are the same, generate a storage control signal; and
a storage unit configured to store the correspondence relationship between each display interface and the position of the display panel to which the display interface is connected based on the storage control signal.

9. The display device of claim 8, wherein the verification unit comprises:
a request subunit configured to issue a verification request for obtaining an operation instruction;
a receiving subunit configured to receive the operation instruction; and
an analyzing subunit configured to:
when the operation instruction received by the receiving subunit is a manual verification instruction, control the request subunit to issue a determination result request, and when the operation instruction received by the receiving subunit is a determination result instruction, determine whether the screen image and the preset verification image are the same according to the determination result; and
when the operation instruction received by the receiving subunit is an automatic verification instruction, control the image acquisition unit to acquire the screen image and determine whether the screen image and the preset verification image are the same.

10. The display device according to claim 8, wherein the position obtaining module further comprises an alert unit configured to issue an alert signal in response to a difference between the screen image and the preset verification image.

11. A display method of the display device according to claim 1, comprising steps of:
outputting test signals including interface identification information to the plurality of display interfaces, respectively; generating, by each display panel, a feedback signal including position identification information based on the test signal, the position identification information indicating a position of the display panel in the spliced screen;
determining a correspondence relationship between each display interface and a position of the display panel to which the display interface is connected according to the interface identification information and the feedback signal; and
outputting a display signal indicating a portion of an image to be displayed to each display interface according to the correspondence relationship, so that the plurality of display panels display the images to be displayed together.

12. The display method according to claim 11, wherein the step of determining the correspondence relationship between each display interface and the position of the display panel to which the display interface is connected according to the interface identification information and the feedback signal comprises steps of:
receiving the feedback signal; and,
matching each of the feedback signals with any one of the interface identification information to determine the correspondence relationship between each display interface and the position of the display panel to which the display interface is connected.

13. The display method according to claim 12, wherein each test information is adapted to drive a corresponding display panel to be illuminated to form a screen image on the spliced screen, and
wherein the step of generating, by each display panel, the feedback signal including the position identification information based on the test signal includes steps of:
acquiring a screen image as the feedback signal; and
identifying the screen image to acquire the position identification information indicating the position of each display panel, which is emitting light, in the spliced screen.

14. The display method according to claim 13, wherein the step of determining the correspondence relationship between each display interface and the position of the display panel to which the display interface is connected according to the interface identification information and the feedback signal comprises a step of:
sequentially outputting the test signals, for driving the corresponding display panels to emit light, to the plurality of display interfaces, the order of outputting the test signals to the plurality of display interfaces being defined as the interface identification information.

15. The display method according to claim 14, wherein the position identification information of each display panel is sequentially matched with the interface identification information of the corresponding display interface to obtain the correspondence relationship.

16. The display method according to claim 13, wherein different test signals, for driving the plurality of display panels to emit light, are simultaneously outputted to the plurality of display interfaces, respectively, distinguishing feature of each test signal being defined as the interface identification information.

17. The display method according to claim 16, wherein the step of determining the correspondence relationship between each display interface and the position of the display panel to which the display interface is connected according to the interface identification information and the feedback signal comprises a step of:
matching the position identification information of the screen images of the plurality of display panels and the shape features of the displayed images with the interface identification information of the plurality of display interfaces, respectively, to obtain the correspondence relationship.

18. The display method according to claim 13, wherein before performing the step of outputting the display signal indicating the portion of the image to be displayed to each display panel according to the correspondence relationship, the display method further comprises steps of:
outputting a display signal corresponding to a portion of the preset verification image to each display interface according to the correspondence relationship; and
determining whether the screen image displayed by the spliced screen and the preset verification image are the same, and if they are the same, storing the correspondence relationship between each current display interface and the position of the display panel to which the display interface is connected.

19. The display method according to claim 18, wherein the step of determining whether the screen image displayed by the spliced screen and the preset verification image are the same includes steps of:
issuing a verification request for obtaining an operation instruction;
receiving the operation instruction, and
when the received operation instruction is a manual verification instruction, issuing a determination result obtaining request, and when the received operation instruction is a determination result instruction, determining whether the screen image and the preset verification image are the same according to the determination result instruction; and when the received operation instruction is an automatic verification instruction, acquiring the screen image, and determining whether the screen image and the preset verification image are the same.

20. The display method according to claim 16, wherein if it is determined that the screen image is different from the preset verification image, then an alert signal is issued.
